(19) United States
(12) Patent Application Publication
(10) Pub. No.: US 2012/0172569 A1
(43) Pub. Date: Jul. 5, 2012

(54) THERMOSETTING RESIN HAVING BENZOXAZINE RING AND METHOD FOR PRODUCING THE SAME

(75) Inventors: Tomoaki Katagiri, Tsukuba-shi (JP); Nobuhiro Mori, Tsukuba-shi (JP)

(73) Assignee: SEKISUI CHEMICAL CO., LTD., Osaka-shi Osaka (JP)

(21) Appl. No.: 13/496,144

(22) PCT Filed: Sep. 29, 2010
(86) PCT No.: PCT/JP2010/066939

§ 371 Date: Mar. 14, 2012

(30) Foreign Application Priority Data
Sep. 30, 2009 (JP) 2009-228803

(51) Int. Cl. C08G 14/073

(52) U.S. Cl. 528/127

(57) ABSTRACT

To provide a thermosetting resin having a benzoxazine ring, having excellent dimensional stability. A thermosetting resin having a benzoxazine ring, comprising a structure A represented by the following formula (1) and a structure B represented by the following formula (2):

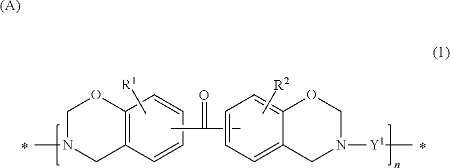

wherein R¹ and R² each independently represent hydrogen or an organic group having 1 to 20 carbon atoms, Y¹ represents an organic group that is an aliphatic diamine residue having a linear, branched, or cyclic structure or an aromatic diamine residue, wherein the organic group has 1 to 20 carbon atoms and may comprise a hetero element, and n represents an integer of 1 to 500; and * represents a bonding site,

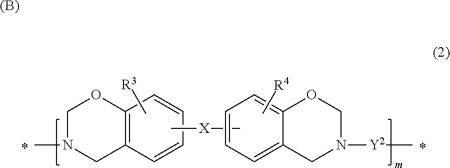

wherein R³ and R⁴ each independently represent hydrogen or an organic group having 1 to 20 carbon atoms, X represents an aliphatic organic group having a linear, branched, or cyclic structure or an aromatic organic group, wherein the organic group has 1 to 20 carbon atoms and may comprise a hetero element, Y² represents an organic group that is an aliphatic diamine residue having a linear, branched, or cyclic structure or an aromatic diamine residue, wherein the organic group has 1 to 20 carbon atoms and may comprise a hetero element, and m represents an integer of 1 to 500; and * represents a bonding site.

### TECHNICAL FIELD

The present invention relates to a thermosetting resin having a benzoxazine ring, a method for producing the thermosetting resin, a thermosetting resin composition comprising the thermosetting resin, and molded articles and cured articles thereof, and electronic devices comprising the same.

### BACKGROUND ART

A thermosetting resin having a benzoxazine ring in the molecular structure has good heat resistance, good flame retardancy, good electrical insulation properties, good low water absorbency, and the like, and has excellent properties, which are not seen in other thermosetting resins. Therefore, it attracts attention as electronics materials, such as laminates and semiconductor sealing materials, and bonding materials, such as friction materials and grindstones.

The thermosetting resin having a benzoxazine ring is a thermosetting resin having a structure in which an oxazine ring is adjacent to a benzene ring, and can be produced, for example, by reacting a phenol compound, an amine compound, and an aldehyde compound. One example of such a thermosetting resin having a benzoxazine ring may include a thermosetting resin having a benzoxazine ring produced using phenol as a phenol compound, aniline as an amine compound, and formaldehyde as an aldehyde compound (please see the left in the formula (i)).

As shown in the formula (i), the thermosetting resin having a benzoxazine ring (please see the left in the formula (i)) is subjected to ring-opening polymerization by heating to provide polybenzoxazine (please see the right in the formula (i)).

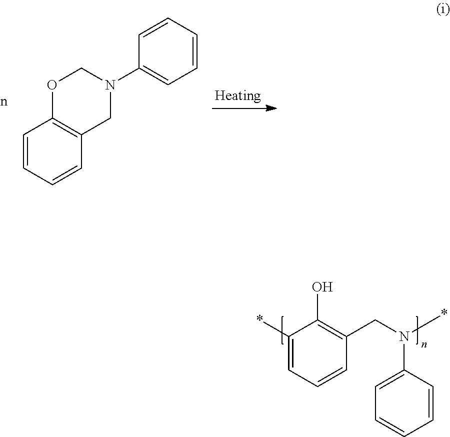

Regarding such a thermosetting resin having a benzoxazine ring, for example, Patent Documents 1 and 2 and Non-Patent Document 1 disclose thermosetting resins having a benzoxazine ring obtained by reacting bifunctional phenols, diamines, and aldehydes.
Patent Document 1: Japanese Patent Laid-Open No. 2003-64180
Patent Document 2: U.S. Patent Application Publication No. 2003/0023007

### Non-Patent Document

Non-Patent Document 1: Polymer Preprints, Japan Vol. 57, No. 1, p 1480 (2008)

### SUMMARY OF THE INVENTION

### Problems to be Solved by the Invention

However, the thermosetting resins having a benzoxazine ring disclosed in Patent Documents 1 and 2 and Non-Patent Document 1 are susceptible to improvement in dimensional stability, particularly a lower coefficient of linear thermal expansion. A molded article of a thermosetting resin having a benzoxazine ring, and a cured article obtained by curing the molded article are materials having somewhat good physical properties, but are not sufficient yet. Such performance improvement is strongly desired for such a molded article and the like, particularly when the cured article of the thermosetting resin having a benzoxazine ring is formed into the shape of a film or the like for use.

The present invention has been made in view of the above circumstances. It is a main object of the present invention to provide a thermosetting resin having a benzoxazine ring, having excellent dimensional stability.

### Means for Solving the Problems

The present inventors have studied diligently to solve the above problems, and, as a result, found that the above problems can be solved by providing a thermosetting resin having a benzoxazine ring having a particular structure in the molecule, leading to the completion of the present invention.

Specifically, the present invention is as follows.

[1]

A thermosetting resin having a benzoxazine ring, comprising a structure A represented by the following formula (1) and a structure B represented by the following formula (2):

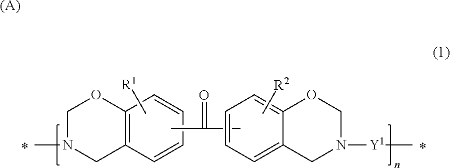

wherein R¹ and R² each independently represent hydrogen or an organic group having 1 to 20 carbon atoms, Y¹ represents an organic group that is an aliphatic diamine residue having a linear, branched, or cyclic structure or an aromatic diamine residue, wherein the organic group has 1 to 20 carbon atoms and may comprise a hetero element, and n represents an integer of 1 to 500; and * represents a bonding site,

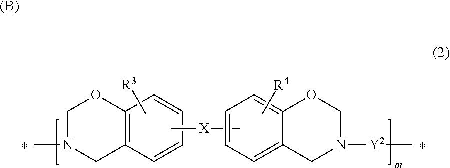

wherein R³ and R⁴ each independently represent hydrogen or an organic group having 1 to 20 carbon atoms, X represents an aliphatic organic group having a linear, branched, or cyclic structure or an aromatic organic group, wherein the organic group has 1 to 20 carbon atoms and may comprise a hetero element, Y² represents an organic group that is an aliphatic diamine residue having a linear, branched, or cyclic structure or an aromatic diamine residue, wherein the organic group has 1 to 20 carbon atoms and may comprise a hetero element, and m represents an integer of 1 to 500; and * represents a bonding site.

[2]

The thermosetting resin having a benzoxazine ring according to [1], wherein R¹ and R² in the structure A are each hydrogen.

[3]

The thermosetting resin having a benzoxazine ring according to [1] or [2], wherein R¹ and R² in the structure A, and R³ and R⁴ in the structure B are each hydrogen.

[4]

The thermosetting resin according to any one of [1] to [3], wherein a ratio of a content of the structure A to a content of the structure B (A/B; molar ratio) in the thermosetting resin is from 1/99 to 99/1.

[5]

The thermosetting resin according to any one of [1] to [4], wherein the ratio of the content of the structure A to the content of the structure B (NB; molar ratio) in the thermosetting resin is from 70/30 to 90/10.

[6]

The thermosetting resin having a benzoxazine ring according to any one of [1] to [5], wherein at least either one of Y¹ and Y² is a structure represented by the following formula (3):

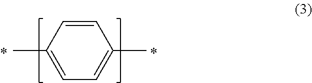

wherein * represents a bonding site.

[7]

The thermosetting resin having a benzoxazine ring according to any one of [1] to [6], wherein at least either one of Y¹ and Y² is a structure represented by the following formula (4):

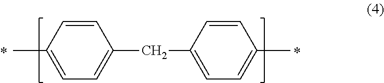

wherein * represents a bonding site.

[8]

The thermosetting resin having a benzoxazine ring according to any one of [1] to [7], wherein X is at least one selected from the group consisting of the following group G1a:

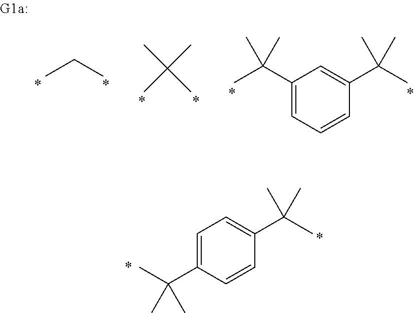

wherein * represents a bonding site.

[9]

A thermosetting resin having a benzoxazine ring obtained by reacting a compound represented by the following formula (5), a compound represented by the following formula (6), a diamine compound, and an aldehyde compound:

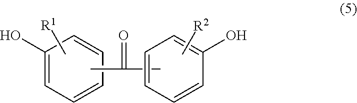

wherein R¹ and R² each independently represent hydrogen or an organic group having 1 to 20 carbon atoms,

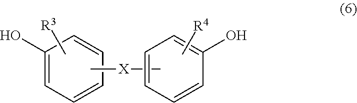

wherein R³ and R⁴ each independently represent hydrogen or an organic group having 1 to 20 carbon atoms, and X represents an aliphatic organic group having a linear, branched, or cyclic structure or an aromatic organic group, wherein the organic group has 1 to 20 carbon atoms and may comprise a hetero element.

[10]

The thermosetting resin having a benzoxazine ring according to [9], wherein the diamine compound is at least either one of a compound represented by the following formula (7) and a compound represented by the following formula (8):

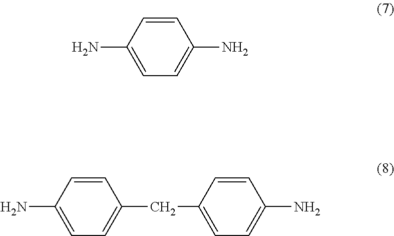

[11]

The thermosetting resin having a benzoxazine ring according to [9] or [10], wherein the reaction is performed in a lactone solvent.

[12]

A method for producing a thermosetting resin having a benzoxazine ring, comprising a step of reacting a compound represented by the following formula (5), a compound represented by the following formula (6), a diamine compound, and an aldehyde compound:

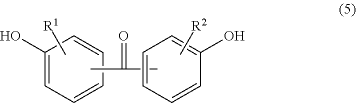

wherein R¹ and R² each independently represent hydrogen or an organic group having 1 to 20 carbon atoms,

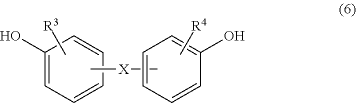

wherein R³ and R⁴ each independently represent hydrogen or an organic group having 1 to 20 carbon atoms, and X represents an aliphatic organic group having a linear, branched, or cyclic structure or an aromatic organic group, wherein the organic group has 1 to 20 carbon atoms and may comprise a hetero element.

[13]

A thermosetting resin composition comprising the thermosetting resin according to any one of [1] to [11], or the thermosetting resin obtained by the method according to [12].

[14]

A molded article obtained by molding the thermosetting resin according to any one of [1] to [11], the thermosetting resin obtained by the method according to [12], or the thermosetting resin composition according to [13].

[15]

A cured article obtained by curing the molded article according to [14].

[16]

An electronic device comprising a molded article according to [14] or a cured article according to [15].

### Advantageous Effects of the Invention

The present invention can provide a thermosetting resin having a benzoxazine ring, having excellent dimensional stability.

### BRIEF DESCRIPTION OF DRAWINGS

FIG. 1 shows the proton nuclear magnetic resonance spectrum (¹H-NMR spectrum) of a thermosetting resin having a benzoxazine ring produced in Example 1.

FIG. 2 shows the proton nuclear magnetic resonance spectrum (¹H-NMR spectrum) of a thermosetting resin having a benzoxazine ring produced in Example 2.

FIG. 3 shows the proton nuclear magnetic resonance spectrum (¹H-NMR spectrum) of a thermosetting resin having a benzoxazine ring produced in Example 3.

FIG. 4 shows the proton nuclear magnetic resonance spectrum (¹H-NMR spectrum) of a thermosetting resin having a benzoxazine ring produced in Example 4.

FIG. 5 shows the proton nuclear magnetic resonance spectrum (¹H-NMR spectrum) of a thermosetting resin having a benzoxazine ring produced in Example 5.

FIG. 6 shows the proton nuclear magnetic resonance spectrum (¹H-NMR spectrum) of a thermosetting resin having a benzoxazine ring produced in Example 6.

FIG. 7 shows the proton nuclear magnetic resonance spectrum (¹H-NMR spectrum) of a thermosetting resin having a benzoxazine ring produced in Example 7.

### MODES FOR CARRYING OUT THE INVENTION

An embodiment for carrying out the present invention (hereinafter, referred to simply as “the present embodiment”) will now be described in detail. The following present embodiment is an illustrative example for describing the present invention, and does not limit the present invention to what is described below. The present invention may be carried out with various appropriate modifications made within the scope of the invention.

A thermosetting resin having a benzoxazine ring according to the present embodiment is a thermosetting resin having a benzoxazine ring, comprising a structure A represented by the following formula (1) and a structure B represented by the following formula (2). By having both the structures A and B, the thermosetting resin has a moderately rigid skeleton, and has excellent dimensional stability, excellent solubility in organic solvents, and excellent compatibility with other formulated materials. Therefore, an advantage of the thermosetting resin is that there is a wide choice of other formulated materials when a thermosetting resin composition and the like described later are provided (however, the mechanism of the present embodiment is not limited to this). Particularly, in the thermosetting resin having a benzoxazine ring according to the present embodiment, the coefficient of linear thermal expansion (CTE) can be significantly reduced, compared with conventional ones, and therefore, also from this viewpoint, the thermosetting resin can be a thermosetting resin having excellent dimensional stability.

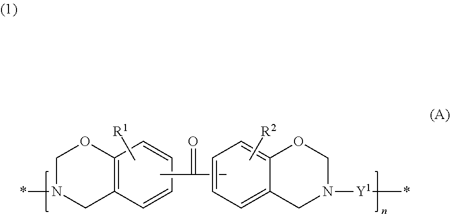

wherein R¹ and R² each independently represent hydrogen or an organic group having 1 to 20 carbon atoms, Y¹ each independently represents an organic group that is an aliphatic diamine residue having a linear, branched, or cyclic structure or an aromatic diamine residue, wherein the organic group has 1 to 20 carbon atoms and may comprise a hetero element, and n represents an integer of 1 to 500; and * represents a bonding site.

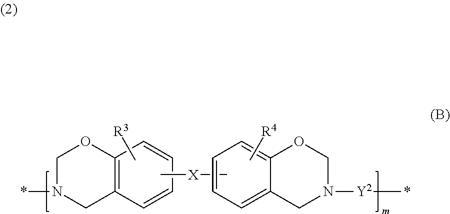

wherein R³ and R⁴ each independently represent hydrogen or an organic group having 1 to 20 carbon atoms, X represents an aliphatic organic group having a linear, branched, or cyclic structure or an aromatic organic group, wherein the organic group has 1 to 20 carbon atoms and may comprise a hetero element, Y² each independently represents an organic group that is an aliphatic diamine residue having a linear, branched, or cyclic structure or an aromatic diamine residue, wherein the organic group has 1 to 20 carbon atoms and may comprise a hetero element, and m represents an integer of 1 to 500; and * represents a bonding site.

In the present embodiment, the ratio of the content of the structure A to the content of the structure B (A/B; molar ratio) in the thermosetting resin is not particularly limited, but is preferably from 1/99 to 99/1, more preferably from 10/90 to 90/10, further preferably from 50/50 to 90/10, and further preferably from 70/30 to 90/10. When the lower limit value of the ratio of the content of the structure A to the content of the structure B (NB; molar ratio) is 1/99 or more, the coefficient of linear thermal expansion (CTE) when a molded article, such as a cured film, is provided tends to be further reduced, for the obtained resin. When the upper limit value is 99/1 or less, compatibility with other materials, solubility in the solvent used for preparation, and the like tend to be further improved, and flexibility when a molded article, such as a cured film, is provided tends to be further improved, for the obtained resin. The ratio of the contents of the structure A and the structure B here can be obtained by ¹H-NMR.

Y¹ and Y² in the formulas (1) and (2) each independently represent an organic group that is an aliphatic diamine residue having a linear, branched, or cyclic structure or an aromatic diamine residue, wherein the organic group has 1 to 20 carbon atoms and may comprise a hetero element. Particularly, it is preferable that at least either one of Y¹ and Y² be a structure represented by the following formula (3). Alternatively, it is preferable that at least either one of Y¹ and Y² be a structure represented by the following formula (4). Y¹ and Y² may be the same as or may be different from each other.

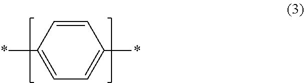

wherein * represents a bonding site.

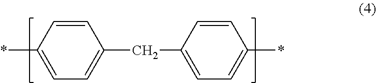

wherein * represents a bonding site.

m and n in the formulas (1) and (2) are each independently an integer of 1 to 500 and are each independently preferably an integer of 1 to 250.

The thermosetting resin having a benzoxazine ring in the present embodiment can be obtained by reacting a compound represented by the following formula (5), a compound represented by the following formula (6), a diamine compound, and an aldehyde compound. In the present embodiment, at least the compound represented by the formula (5) and the compound represented by the formula (6) are used as bifunctional phenols. The thermosetting resin having a benzoxazine ring, comprising the structure A represented by the formula (1) and the structure B represented by the formula (2), can be obtained by reacting these bifunctional phenols, a diamine compound, and an aldehyde compound.

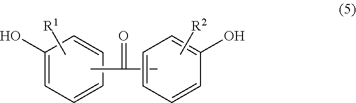

wherein R¹ and R² each independently represent hydrogen or an organic group having 1 to 20 carbon atoms. When R¹ and R² are organic groups, their structures are not particularly limited, and they may be, for example, aliphatic organic groups having a linear, branched, or cyclic structure or aromatic organic groups, which may comprise a hetero element or a functional group. R¹ and R² may be the same as or may be different from each other. Examples of the functional group may include ether groups, alkoxy groups, ketone groups, ester groups, amide groups, and carboxyl groups.

In the formula (5), the carbonyl group is bonded at any of an ortho position, a meta position, and a para position with respect to the bonding positions of the right and left hydroxyl groups, and the bonding positions of the carbonyl group may be the same position, or may be different from each other, such as an ortho position and a para position, in the right and left benzene rings.

The bifunctional phenol compound represented by the formula (5) is not particularly limited and examples thereof may include 4,4′-dihydroxybenzophenone (DHBP), bis(4-hydroxyphenyl)sulfone (bisphenol S), 4,4′-biphenol, and 1,4-benzenediol (hydroquinone). Among these, 4,4′-dihydroxybenzophenone (DHBP) is preferred. By using the bifunctional phenol compound, a lower coefficient of linear thermal expansion is more significant. Particularly, by using DHBP as the bifunctional phenol compound, a lower coefficient of linear thermal expansion is more significant. One of the bifunctional phenol compounds represented by the formula (5) may be used alone, or two or more may be used in combination.

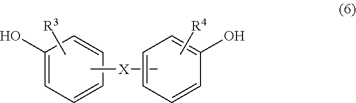

wherein R³ and R⁴ each independently represent hydrogen or an organic group having 1 to 20 carbon atoms, and X represents an aliphatic organic group having a linear, branched, or cyclic structure or an aromatic organic group, wherein the organic group has 1 to 20 carbon atoms and may comprise a hetero element.

When R³ and R⁴ are organic groups, their structures are not particularly limited, and they may be, for example, aliphatic organic groups having a linear, branched, or cyclic structure or aromatic organic groups, which may comprise a hetero element or a functional group. R³ and R⁴ may be the same as or may be different from each other. Here, examples of the functional group may include ether groups, alkoxy groups, ketone groups, ester groups, amide groups, and carboxyl groups.

In the formula (6), X is bonded at any of an ortho position, a meta position, and a para position with respect to the bonding positions of the right and left hydroxyl groups, and the bonding positions of X may be the same position, or may be different from each other, such as an ortho position and a para position, in the right and left benzene rings.

X may be at least one selected from the group consisting of the following group G1. Among these, at least one selected from the group consisting of the following G1a is preferred in terms of compatibility with other materials, solubility in the solvent used for preparation, and flexibility when a molded article, such as a cured film, is provided.

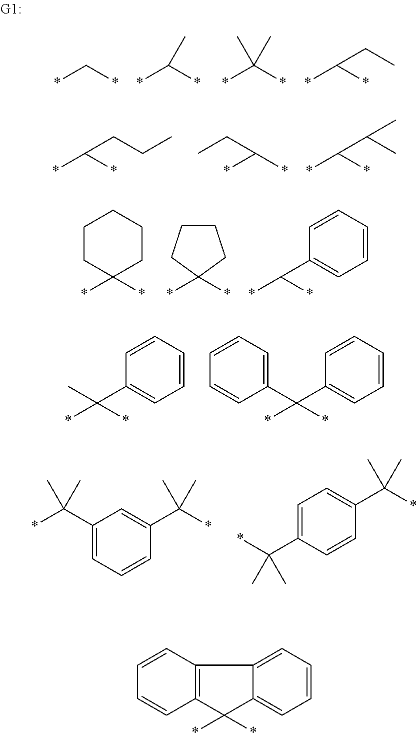

wherein * represents a bonding site.

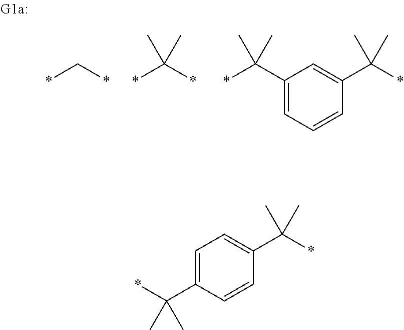

wherein * represents a bonding site.

The bifunctional phenol compound represented by the formula (6) is not particularly limited and examples thereof may include 4,4′-dihydroxydiphenyl-2,2-propane (bisphenol A), 4,4′-[1,3-phenylenebis(1-methyl-ethylidene)]bisphenol (bisphenol M), 4,4′-[1,4-phenylenebis(1-methyl-ethylidene)]bisphenol (bisphenol P), and 4,4′-methylenediphenol (bisphenol F). Among these, 4,4′-dihydroxydiphenyl-2,2-propane (bisphenol A) is preferred in terms of compatibility with other materials, solubility in the solvent used for preparation, and flexibility when a molded article, such as a cured film, is provided. One of the bifunctional phenol compounds represented by the formula (6) may be used alone, or two or more may be used in combination.

The diamine compound is not particularly limited, and aliphatic diamine compounds having a linear structure or a branched structure, alicyclic diamine compounds, aromatic diamine compounds, and the like can be used. These may be substituted or may be unsubstituted, and may comprise a hetero element or a functional group. Here, examples of the functional group may include ether groups, alkoxy groups, ketone groups, ester groups, amide groups, and carboxyl groups.

The alicyclic diamine compounds are not particularly limited and examples thereof may include compounds represented by the formula (9) and compounds represented by the formula (10):

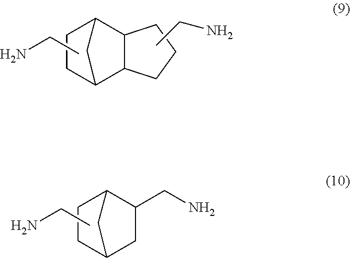

The compounds represented by the formula (9) and the compounds represented by the formula (10) may each be a cis isomer, a trans isomer, or any mixture of a cis isomer and a trans isomer.

The linear aliphatic diamine compounds are not particularly limited and examples thereof may include linear aliphatic diamine compounds selected from the group consisting of the following group G2:

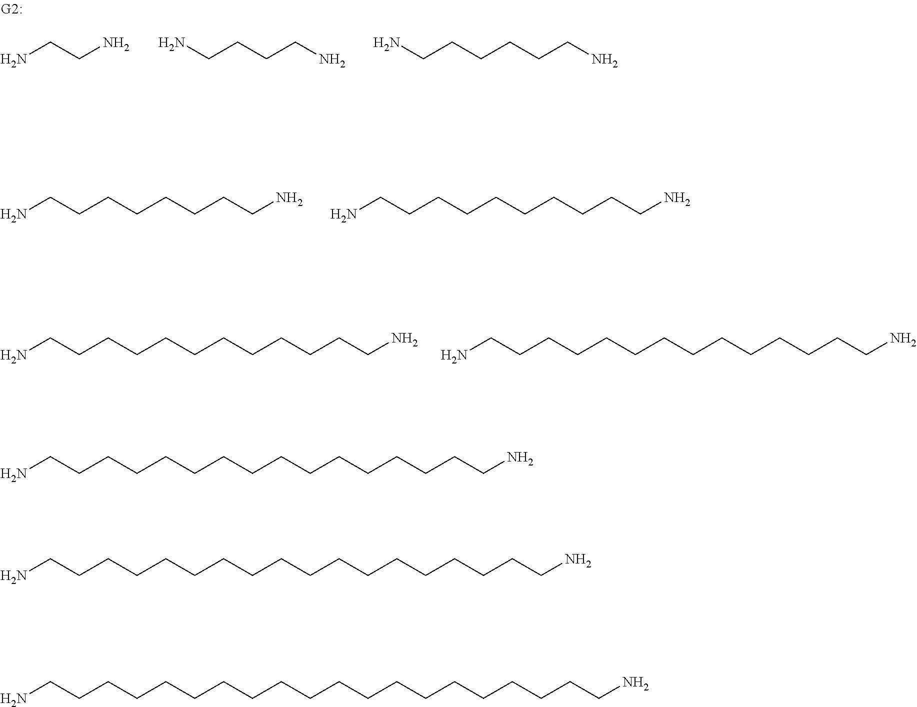

In addition, the aromatic diamine compounds are not particularly limited and examples thereof may include compounds represented by the following formula (11), compounds represented by the following formula (12), and aromatic diamine compounds represented by the following formula (13):

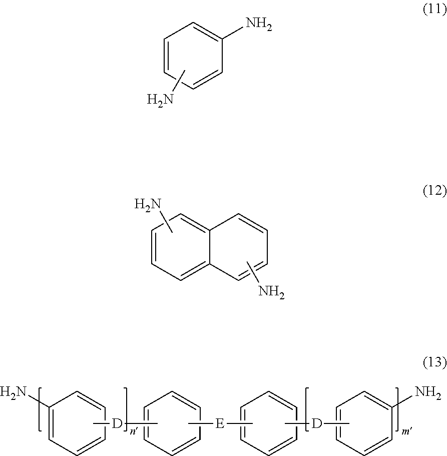

Examples of the compounds represented by the formula (11) may include a compound represented by the following formula (7) (p-phenylenediamine).

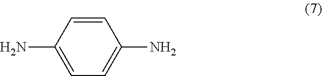

wherein D each independently represents a direct bond (no atom or atomic group is present), or an aliphatic organic group having a linear, branched, or cyclic structure or an aromatic organic group, which may comprise a hetero element or a functional group. In the formula (13), D may be the same as or may be different from each other. E represents a direct bond (no atom or atomic group is present), or an aliphatic organic group having a linear, branched, or cyclic structure or an aromatic organic group, which may comprise a hetero element or a functional group. The above aliphatic organic groups or aromatic organic groups may each have a substituent. Examples of the substituent may include aliphatic hydrocarbon groups having a linear, branched, or cyclic structure or substituted or unsubstituted aromatic hydrocarbon groups, wherein the hydrocarbon groups each have 1 to 20 carbon atoms. Here, examples of the functional group may include ether groups, alkoxy groups, ketone groups, ester groups, amide groups, and carboxyl groups.

In the formula (13), n′ and m′ each independently represent an integer of 0 to 10.

Each aromatic ring in the formula (11), the formula (12), and the formula (13) may have a substituent. The substituent is not particularly limited and examples thereof may includes aliphatic hydrocarbon groups having a linear, branched, or cyclic structure or aromatic hydrocarbon groups, wherein the hydrocarbon groups each have 1 to 20 carbon atoms. The substituent may comprise a hetero element or a functional group. Here, examples of the functional group may include ether groups, alkoxy groups, ketone groups, ester groups, amide groups, and carboxyl groups.

In the formula (13), D is bonded at any of an ortho position, a meta position, and a para position with respect to the bonding positions of the right and left amino groups, and the bonding positions of D may be the same position, or may be different from each other, such as an ortho position and a para position, in the right and left benzene rings. E is bonded at any of an ortho position, a meta position, and a para position with respect to the bonding positions of the right and left D, and the bonding positions of E may be the same position, or may be different from each other, such as an ortho position and a para position, in the right and left benzene rings.

When the diamine compound is the compound represented by the formula (13) and D in the formula (13) is the above organic group, D may be at least either one selected from the group consisting of the following group G3:

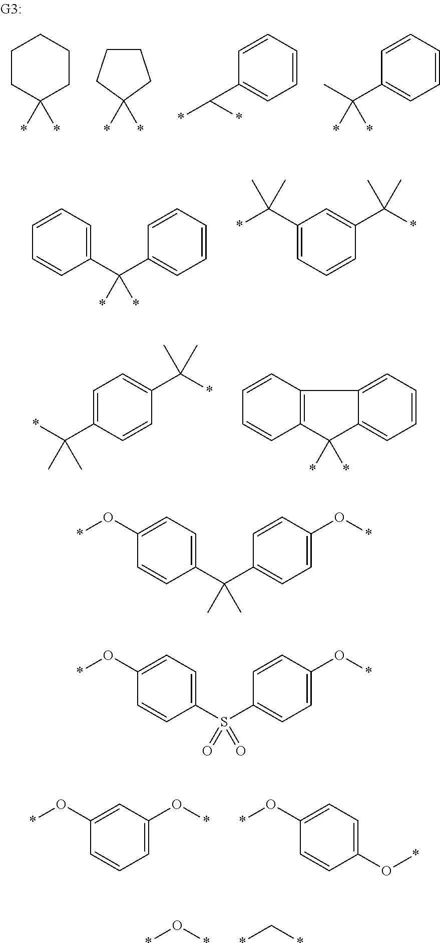

wherein * represents a bonding site.

When the diamine compound is the compound represented by the formula (13) and E in the formula (13) is the above organic group, E may be at least either one selected from the group consisting of the following group G4:

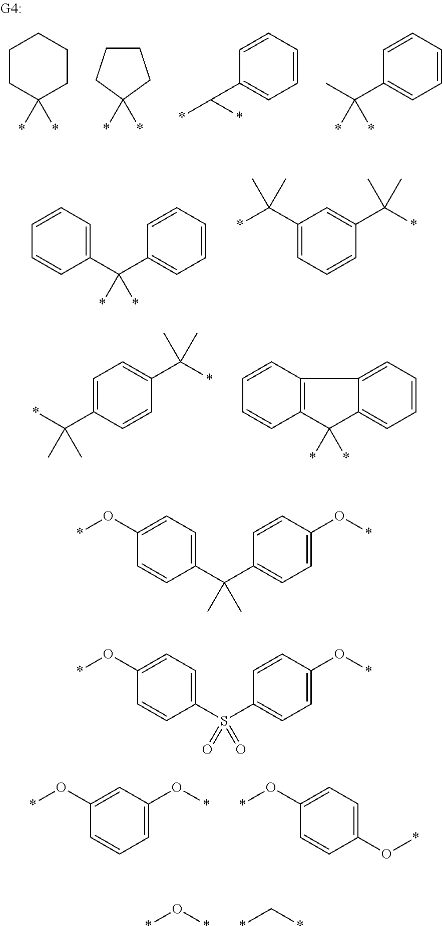

wherein * represents a bonding site.

In the formula (13), n′ and m′ are each independently an integer of 0 to 10, and are each independently preferably an integer of 0 to 5, and more preferably 0 to 1 in terms of the ease of availability.

In the formula (13), when n′ and m′ are 0, the diamine compound is a compound represented by the following formula (14):

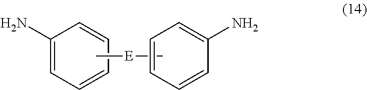

In the formula (14), E represents a direct bond (no atom or atomic group is present), or an aliphatic organic group having a linear, branched, or cyclic structure or an aromatic organic group, which may comprise a hetero element or a functional group. Examples of the functional group may include ether groups, alkoxy groups, ketone groups, ester groups, amide groups, and carboxyl groups.

When E in the formula (14) is an aliphatic organic group or an aromatic organic group, each may have a substituent. Examples of the substituent may include aliphatic hydrocarbon groups having a linear, branched, or cyclic structure or substituted or unsubstituted aromatic hydrocarbon groups, wherein the hydrocarbon groups each have 1 to 20 carbon atoms.

In the formula (14), E is bonded at any of an ortho position, a meta position, and a para position with respect to the bonding positions of the right and left amino groups, and the bonding positions of E may be the same position, or may be different from each other, such as an ortho position and a para position, in the right and left benzene rings.

Examples of the compound represented by the formula (14) may include a compound represented by the following formula (8) (4,4′-diaminodiphenylmethane).

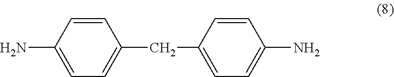

The diamine compound is not particularly limited. Specific examples of the diamine compound may include alicyclic diamine compounds, such as 3(4),8(9),-bis(aminomethyl)tricyclo[5.2.1.0^{2,6}]decane and 2,5(6)-bis(aminomethyl)bicyclo[2.2.1]heptane; linear aliphatic diamine compounds, such as 1,2-diaminoethane, 1,6-diaminohexane, 1,10-diaminodecane, 1,12-diaminododecane, 1,14-diaminotetradecane, and 1,18-diaminooctadecane; branched aliphatic diamine compounds, such as tetramethyl-1,3-diaminopropane; and aromatic diamine compounds, such as p-phenylenediamine, 4,4′-diaminodiphenylmethane, 4,4′-diamino-3,3′-dimethyldiphenylmethane, 4,4′-diamino-3,3′-diethyldiphenylmethane, 4,4′-diamino-3,3′,5,5′-tetramethyldiphenylmethane, 4,4′-diamino-3,3′,5,5′-tetraethyldiphenylmethane, 4,4′-diaminodiphenyl ether, 2,2′-bis[4-(4-aminophenoxy)phenyl]propane, 4,4′-[1,3-phenylenebis(1-methyl-ethylidene)]bisaniline (bisaniline M), 4,4′-[1,4-phenylenebis(1-methyl-ethylidene)]bisaniline (bisaniline P), 1,3-bis(4-aminophenoxy)benzene, 1,4-bis(4-aminophenoxy)benzene, 4,4′-diaminobiphenyl, and 4,4′-bis(4-aminophenoxy)biphenyl. Among these, p-phenylenediamine, 4,4′-diaminodiphenylmethane, and 4,4′-diaminobiphenyl are preferred in terms of a lower coefficient of linear thermal expansion. One of these diamine compounds may be used alone, or two or more may be used in combination.

The amount of the diamine compound used is preferably from 0.1 to 2 mol, more preferably from 0.3 to 1.8 mol, and further preferably from 0.5 to 1.5 mol, based on 1 mol of all bifunctional phenol compounds. This means that, for example, when only the compound represented by the formula (5) and the compound represented by the formula (6) are used as the bifunctional phenol compounds, the amount of the diamine compound used is in the above range based on 1 mol of the total of the compound represented by the formula (5) and the compound represented by the formula (6). When the amount of the diamine compound used, based on 1 mol of the bifunctional phenol compounds, is 2 mol or less, the gelation of the reaction solution can be effectively suppressed. When the amount of the diamine compound used, based on 1 mol of the bifunctional phenol compounds, is 0.1 mol or more, the bifunctional phenol compounds can be sufficiently reacted, without remaining, to provide the thermosetting resin having a benzoxazine ring, having higher molecular weight.

In the present embodiment, the bifunctional phenol compound represented by the formula (5) and the bifunctional phenol compound represented by the formula (6) can be used in combination in order to synthesize the thermosetting resin having a benzoxazine ring. In this case, the amount of the bifunctional phenol compound represented by the formula (6) is preferably from 1 to 99 mol %, more preferably from 10 to 90 mol %, further preferably from 10 to 50 mol %, and still further preferably from 10 to 30 mol %, with respect to all bifunctional phenols. In a case where the bifunctional phenol compound represented by the formula (5) and the bifunctional phenol compound represented by the formula (6) are used in combination, when the amount of the bifunctional phenol compound represented by the formula (6) is the above lower limit value or more, compatibility with other materials, solubility in the solvent used for preparation and the like tend to be further improved, and flexibility when a molded article, such as a cured film, is provided tends to be further improved, for the obtained resin. When the amount of the bifunctional phenol compound represented by the formula (6) is the above upper limit value or less, the coefficient of linear thermal expansion when a molded article, such as a cured film, is provided tends to be further reduced, for the obtained resin.

The aldehyde compound is not particularly limited, but formaldehyde is preferred. Formaldehyde can be used in the form of paraformaldehyde, which is a polymer of formaldehyde, formalin, which is an aqueous solution, or the like. In addition, formaldehyde can also be used as hemiacetals obtainable by reacting formaldehyde or paraformaldehyde with alcohols. This alcohol is not particularly limited and examples thereof may include methanol, ethanol, 1-propanol, isopropanol, 1-butanol, and 2-butanol. Among these, methanol is preferred in terms of the ease of distilling off. One alcohol may be used alone, or two or more alcohols may be used in combination.

The amount of the aldehyde compound used is preferably from 4 to 8 mol, more preferably from 4 to 7 mol, and further preferably from 4 to 6 mol, based on 1 mol of the diamine compound. When the amount of the aldehyde compound used is 8 mol or less, the effect on the human body and environment can be reduced. When the amount of the aldehyde compound used is 4 mol or more, the thermosetting resin having a benzoxazine ring can have higher molecular weight.

In the method for producing the thermosetting resin having a benzoxazine ring, a monofunctional phenol compound may be further added, together with the bifunctional phenol compounds, for reaction. When a monofunctional phenol compound is used in combination, a polymer in which a reactive end is capped by a benzoxazine ring is produced. As a result, the molecular weight of the polymer can be controlled during the synthesis reaction, and the gelation of the solution can be effectively prevented. In addition, by capping the reactive end of the polymer, it is also possible to improve the storage stability of the thermosetting resin having a benzoxazine ring. As a result, the insolubilization of the thermosetting resin having a benzoxazine ring can be effectively prevented.

The monofunctional phenol compound is not particularly limited and examples thereof may include phenol, o-cresol, m-cresol, p-cresol, p-tert-butylphenol, p-octylphenol, p-cumylphenol, dodecylphenol, o-phenylphenol, p-phenylphenol, 1-naphthol, 2-naphthol, m-methoxyphenol, p-methoxyphenol, m-ethoxyphenol, p-ethoxyphenol, 3,4-dimethylphenol, and 3,5-dimethylphenol. As the monofunctional phenol compound, phenol is preferred in terms of versatility and cost. One monofunctional phenol compound may be used alone, or two or more monofunctional phenol compounds may be used in combination.

The amount of the monofunctional phenol compound used is preferably 0.5 mol or less based on 1 mol of all bifunctional phenol compounds. When the amount of the monofunctional phenol compound used is 0.5 mol or less based on 1 mol of all bifunctional phenol compounds, the thermosetting resin having a benzoxazine ring structure can have higher molecular weight during the synthesis reaction, and the monofunctional phenol compound can be sufficiently reacted to decrease the amount of the remaining monofunctional phenol.

In the present embodiment, known solvents can be used as the solvent, but it is preferable to use a solvent comprising a cyclic ester or lactone solvent, as the synthesis solvent. By using such a solvent, the gelation of the reaction solution or the insolubilization of the reaction product does not occur during the synthesis reaction. Further, the handling properties during the synthesis are good, and the synthesis process can be easy. The cyclic ester or lactone solvent is not particularly limited and examples thereof may include cyclic ester or lactone solvents, such as γ-caprolactone, γ-valerolactone, γ-butyrolactone, β-propiolactone, β-butyrolactone, δ-valerolactone, δ-caprolactone, ε-caprolactone, 3-methyloctano-4-lactone, and 4-hydroxy-3-pentenoic acid γ-lactone. Among these, highly versatile γ-butyrolactone, γ-caprolactone, and γ-valerolactone, and the like are preferred. One cyclic ester or lactone solvent may be used alone, or two or more cyclic ester or lactone solvents may be used in combination.

The solvent may be a mixed solvent of a cyclic ester or lactone solvent and an alcohol. The alcohol is not particularly limited and examples thereof may include methanol, ethanol, 1-propanol, isopropanol, 1-butanol, 2-butanol, isobutanol, 2-methoxyethanol, and 2-ethoxyethanol. Among these, isobutanol and 2-methoxyethanol are preferred. One alcohol may be used alone, or two or more alcohols may be used in combination.

The mixed solvent of a cyclic ester or lactone solvent and an alcohol is not particularly limited, but a combination of γ-butyrolactone and isobutanol, and a combination of γ-butyrolactone and 2-methoxyethanol are preferred in terms of reaction temperature and the like.

In the mixed solvent of a cyclic ester or lactone solvent and an alcohol, the proportion of the alcohol is preferably 50% by volume or less in terms of allowing the synthesis reaction to proceed efficiently. When the proportion of the alcohol is 50% by volume or less, the synthesis reaction of the thermosetting resin having a benzoxazine ring can be performed in a short time, and therefore, the synthesis efficiency can be increased.

The solvent may be a mixed solvent of a cyclic ester or lactone solvent and an aromatic nonpolar solvent. The aromatic nonpolar solvent is not particularly limited and examples thereof may include benzene, toluene, xylene, pseudocumene, and mesitylene. Among these, toluene and xylene are preferred because they are highly versatile and inexpensive. One aromatic nonpolar solvent may be used alone, or two or more aromatic nonpolar solvents may be used in combination.

The mixed solvent of a cyclic ester or lactone solvent and an aromatic nonpolar solvent is not particularly limited, but a combination of γ-butyrolactone and toluene, and a combination of γ-butyrolactone and xylene are preferred in terms of reaction temperature and the like.

In the mixed solvent of a cyclic ester or lactone solvent and an aromatic nonpolar solvent, the proportion of the aromatic nonpolar solvent is preferably 50% by volume or less with respect to the entire mixed solvent, in terms of not decreasing the solubility of the raw materials. When the proportion of the aromatic nonpolar solvent is 50% by volume or less, the raw materials can be more surely dissolved, and the reaction efficiency can be increased.

The solvent may be a mixed solvent of a cyclic ester or lactone solvent, an aromatic nonpolar solvent, and an alcohol. The total of the aromatic nonpolar solvent and the alcohol is preferably 50% by volume or less with respect to the entire mixed solvent, in terms of allowing the synthesis reaction to proceed efficiently, and in terms of not decreasing the solubility of the raw materials in the solvent.

For the amount of the solvent, the mol concentration of the bifunctional phenol compounds is preferably from 0.1 to 5.0 mol/L, more preferably from 0.1 to 4.0 mol/L, and further preferably from 0.1 to 3.0 mol/L. When the mol concentration of the bifunctional phenol compounds is 0.1 mol/L or more, the synthesis reaction rate of the thermosetting resin having a benzoxazine ring can be more promoted, and the reaction efficiency can be increased. When the concentration of the bifunctional phenol compounds is 5.0 mol/L or less, the gelation of the reaction solution can be effectively suppressed, and the insolubilization of the obtained thermosetting resin having a benzoxazine ring can be prevented, during the synthesis reaction of the thermosetting resin having a benzoxazine ring.

In the method for producing the thermosetting resin according to the present embodiment, the order of adding and mixing the raw materials is not particularly limited. For example, the bifunctional phenol compounds, the diamine compound, and the aldehyde compound may be added to the solvent and mixed in order. But, it is preferable to add and mix the bifunctional phenol compounds, the diamine compound, and the solvent to provide a mixed solution, and then add the aldehyde compound to this mixed solution and mix them. In other words, the production method according to the present embodiment may comprise a step of mixing the bifunctional phenol compound (the compound represented by the above formula (5), the compound represented by the above formula (6), and the like), the diamine compound, and the solvent to provide a mixed solution; and a step of further adding the aldehyde compound to the above mixed solution and reacting.

In the method for producing the thermosetting resin according to the present embodiment, heating may be performed, and the bifunctional phenol compounds and the like may be added and mixed, while the solvent is stirred by appropriately using a stirring machine, a stirrer, or the like, in terms of improving reaction efficiency. The reaction may be performed in the presence of an inert gas, such as a nitrogen gas, by purging with the inert gas, as required.

The heating method is not particularly limited and examples thereof may include a method of increasing the temperature to a predetermined temperature at once, using a temperature controller, such as an oil bath, and then keeping the temperature constant.

The predetermined temperature in the heating treatment is not particularly limited as long as it is a temperature at which the efficiency of the synthesis reaction of the thermosetting resin having a benzoxazine ring is intended. But, the reaction solution temperature is preferably in the range of from 10 to 150° C., more preferably from 30 to 150° C., and further preferably in the range of from 50 to 150° C. When the reaction solution temperature is 10° C. or more, the synthesis reaction of the thermosetting resin having a benzoxazine ring can be effectively promoted, and the reaction efficiency can be further increased. When the reaction solution temperature is 150° C. or less, the gelation of the reaction solution can be effectively suppressed, and the insolubilization of the obtained thermosetting resin having a benzoxazine ring can be effectively prevented. While the reaction solution is heated, the solvent may be refluxed.

The method for producing the thermosetting resin according to the present embodiment may further comprise the step of removing water produced by the reaction. By removing water produced by the reaction, it is possible to shorten the synthesis reaction time of the thermosetting resin having a benzoxazine ring, and the efficiency of the reaction can be intended. The method for removing produced water is not particularly limited and examples thereof may include a method of subjecting the produced water to azeotropy with the solvent in the reaction solution. For example, the produced water can be removed from the reaction system by using a pressure-equalizing dropping funnel with a cock, a Dimroth condenser, a Dean-Stark apparatus, or the like. In addition, the produced water may be removed out of the system by setting the pressure in the reaction container to reduced pressure during the reaction step.

The heating duration is not particularly limited, but is, for example, preferably about from 1 to 20 hours, more preferably about from 2 to 15 hours, after the start of the heating. After heating is continued for from 1 to 20 hours after the start of the heating, the reaction solution may be released from contact with the temperature controller, such as an oil bath, and allowed to cool, or may be cooled using a refrigerant or the like.

The method for producing the thermosetting resin according to the present embodiment preferably further comprises, after the step of reacting a solution comprising the compound represented by the formula (5), the compound represented by the formula (6), the diamine compound, and the aldehyde compound, a step of washing the solution after the reaction with a basic aqueous solution. By further comprising the washing step, the unreacted bifunctional phenol compounds and monofunctional phenol compound can be efficiently removed from the reaction solution.

The basic aqueous solution is an aqueous solution of a basic compound dissolved in water, and is not particularly limited. The basic compound is not particularly limited and examples thereof may include sodium hydroxide, potassium hydroxide, and calcium hydroxide. Among these, sodium hydroxide is preferred in terms of versatility.

It is preferable that after the above reaction solution is washed with the basic aqueous solution in the washing step, the above reaction solution be further washed with distilled water or the like. For example, by washing with distilled water several times, ions derived from the basic aqueous solution, such as sodium ions, can be effectively removed.

In the present embodiment, the method for recovering the thermosetting resin having a benzoxazine ring from the reaction solution is not particularly limited and examples thereof may include reprecipitation with a poor solvent, concentration and solidification (the distilling off of the solvent under reduced pressure), and spray drying. In the present embodiment, the reaction solution may be filtered after the reaction, as pretreatment, as required.

The thermosetting resin having a benzoxazine ring obtained by the present embodiment has higher molecular weight. By heating this thermosetting resin, and so on, a ring opening reaction can be promoted, and a cured article can be provided. When the thermosetting resin according to the present embodiment is heated and molded to provide a final product, such as a film, an improvement in physical properties, such as heat resistance and flexibility, can be expected. It is considered that particularly, when the bifunctional phenol compounds and the diamine compound are used, the proportion of the thermosetting resin having a benzoxazine ring obtained after the reaction, maintaining linearity, increases. As a result, the flexibility and heat resistance, such as glass transition temperature and pyrolysis temperature, of a molded article (a final product or the like), such as a film, obtained after curing such a resin tend to be further improved, and the physical properties of the obtained resin can be better (however, the mechanism of the present embodiment is not limited to this).

For the thermosetting resin having a benzoxazine ring according to the present embodiment, the weight-average molecular weight (Mw) in terms of a polyethylene glycol-converted value as measured by gel permeation chromatography (GPC) measurement is preferably from 2000 to 300000, more preferably from 2000 to 100000, further preferably from 3000 to 50000, and still further preferably from 4000 to 30000. In the present embodiment, “a thermosetting resin having a benzoxazine ring, having higher molecular weight” refers to a prepolymer type benzoxazine resin, that is, a thermosetting resin having a structure having a benzoxazine ring in a repeating unit, and means that its weight-average molecular weight is controlled to about from 2000 to 300000.

When the weight-average molecular weight of the thermosetting resin is 2000 or more, the heat resistance and flexibility of a final product obtained by a subsequent ring opening reaction can be increased. Further, the recovery operability of the thermosetting resin having a benzoxazine ring produced in the production method according to the present embodiment can be increased, and the yield can be improved. When the weight-average molecular weight is 300000 or less, the solubility of the thermosetting resin having a benzoxazine ring obtained after the synthesis, in various organic solvents, can be better. In addition, compatibility with other thermosetting resins and the like can be ensured.

In the present embodiment, examples of the method for controlling the weight-average molecular weight of the obtained thermosetting resin may include a method of controlling the weight-average molecular weight of the thermosetting resin having a benzoxazine ring by taking a part of the reaction solution during the synthesis reaction, and measuring the molecular weight of the thermosetting resin having a benzoxazine ring dissolved in the solution by GPC.

The thermosetting resin having a benzoxazine ring can have no halogen atom in the structure, and can also be produced using a solvent comprising no halogen compound as an impurity. Therefore, the thermosetting resin having a benzoxazine ring can also be a thermosetting resin containing substantially no halogen compound.

A curing accelerator, a flame retardant, an inorganic filler, a release agent, an adhesion providing agent, a surfactant, a colorant, a coupling agent, a leveling agent, other thermosetting resins, and the like can be added to the thermosetting resin having a benzoxazine ring, as required, to provide a thermosetting resin composition. The thermosetting resin composition having a benzoxazine ring may further comprise the above-described solvent. The thermosetting resin composition having a benzoxazine ring can be suitably used as electronics materials, such as laminates and semiconductor sealing materials, and bonding materials, such as friction materials and grindstones, by being molded or cured by a conventionally known method.

A molded article or a cured article obtained by molding or curing the thermosetting resin having a benzoxazine ring obtained by the production method in the present embodiment, or a thermosetting resin composition comprising the thermosetting resin by a conventionally known method is suitable for applications, such as multilayer substrates, laminates, sealing agents, and adhesives, as electronic components and electronic devices and their materials.

A molded article in the present embodiment is a molded article obtainable by partially curing the above-described thermosetting resin having a benzoxazine ring or a thermosetting resin composition comprising the thermosetting resin, as required, or without curing it. The molded article in the present embodiment may be one obtainable by once molding the thermosetting resin or the thermosetting resin composition before curing it, and then applying heat to cure it (a cured molded article), or one obtainable by curing the thermosetting resin or the thermosetting resin composition simultaneously with molding it (a cured article) because the above-described thermosetting resin having a benzoxazine ring also has moldability before curing. In addition, its dimensions and shape are not particularly limited and examples thereof may include a film shape, a sheet shape (plate shape), and a block shape. The molded article in the present embodiment may further comprise other sites (for example, a sticky layer).

An electronic device in the present embodiment comprises any one of the above thermosetting resin having a benzoxazine ring, the above thermosetting resin composition, the above molded article, and the above cured article. Particularly, the molded article and the like can be suitably used for applications, such as multilayer substrates, laminates, sealing agents, and adhesives, in which excellent dimensional stability, particularly a lower coefficient of linear thermal expansion, is required, as electronic components and electronic devices and their materials.

In the present embodiment, examples of the electronic device may include cellular phones, display devices, vehicle-mounted devices, computers, and communication devices. In addition, it is also possible to use for aircraft members, automobile members, building members, and the like, and it is possible to use as a heat-resistant binder for a conductive material, particularly a metal filler, to be used for an application for forming a circuit through which direct current or alternating current can flow.

### EXAMPLES

The present invention will be more specifically described below by Examples, but the present invention is not limited to these Examples. Evaluation methods and measurement methods used in the Examples are as follows.

### [Measurement of Weight-Average Molecular Weight (Mw)]

High performance liquid chromatograph system (manufactured by SHIMADZU CORPORATION)

System controller: SCL-10A VP

Liquid feed unit: LC-10AD

VP degasser: DGU-12A

Differential refractometer (RI) detector: RID-10A

Autoinjector: SIL-10AD VP

Column oven: CTO-10AS VP

Column: SHODEX KD803 (exclusion limit molecular weight: 70000)×2 (series)

Column temperature: 50° C.

Flow rate: 0.8 mL/min

Eluent: dimethylformamide (DMF; manufactured by Wako Pure Chemical Industries, Ltd., containing no stabilizer, for HPLC, containing 10 mmol/L of LiBr (lithium bromide))

Sample: 0.7% by mass

Detector: RI

A calibration curve was prepared using standard polyethylene glycols having weight-average molecular weights (Mw) of 20000, 14000, 10000, 8000, 6000, 4000, 3000, 2000, 1500, 1000, 900, 600, 400, 300, and 200 (manufactured by JUNSEI CHEMICAL CO., LTD.) under the above measurement conditions. A weight-average molecular weight (Mw) in terms of a polyethylene glycol-converted value as obtained by GPC measurement was measured by standard polyethylene glycol conversion.

### [Measurement of ¹ H-NMR]

Measurement was performed at a sample concentration of 1.3% by mass, using the following measurement apparatus and solvent.

Measurement apparatus: ECX400 (400 MHz) manufactured by JEOL

Solvent: Deuterated DMSO (dimethyl sulfoxide; manufactured by Sigma-Aldrich) containing 0.05% by volume of TMS (tetramethylsilane), or deuterated chloroform containing 0.05% by volume of TMS (manufactured by Cambridge Isotope Laboratories) was used.

### [Measurement of Coefficient of Linear Thermal Expansion (CTE)]

Measurement was performed, using “TMA/SS6100” manufactured by SII NanoTechnology Inc., in a tensile mode, under a nitrogen atmosphere, under a load of 5 mN, at a temperature increase rate of 5° C./min. The average value (ppm/° C.) of the coefficients of linear thermal expansion (CTE) at 25° C. to 150° C. was obtained. For the measurement sample, an obtained film was cut to a width of 4 mm and a length of 20 mm, and the chucks were set so that the distance between the chucks was 10 mm.

### Example 1

A 300 mL flask equipped with a pressure-equalizing dropping funnel with a cock and a Dimroth condenser was charged with 200 mL of γ-butyrolactone (manufactured by Wako Pure Chemical Industries, Ltd.), 2.59 g of 4,4′-dihydroxybenzophenone (hereinafter referred to as DHBP) (0.012 mol, manufactured by Wako Pure Chemical Industries, Ltd.), 24.66 g of bisphenol A (hereinafter referred to as BisA) (0.108 mol, manufactured by GE Plastics Japan Ltd.), and 23.89 g of 4,4′-diaminodiphenylmethane (hereinafter referred to as MDA) (0.12 mol, manufactured by HODOGAYA CHEMICAL CO., LTD., the product name “DAM”), and a nitrogen gas purge was started in the system (flow rate: 15 mL/min). The reaction solution was stirred at 100° C. for 1 hour. After the dissolution of DHBP, BisA, and MDA was confirmed, 18.87 g of paraformaldehyde (hereinafter referred to as PFA) (0.58 mol, manufactured by MITSUBISHI GAS CHEMICAL COMPANY, INC., purity: 91.60%) was added to the above flask, and the reaction solution was reacted for 5 hours. The reaction solution obtained in this manner was cooled to room temperature, filtered, and then poured into 1 L of methanol to precipitate a product.

The precipitate was dried under reduced pressure to obtain a thermosetting resin having a benzoxazine ring A. The weight-average molecular weight (Mw) of the obtained thermosetting resin having a benzoxazine ring A was about 10000.

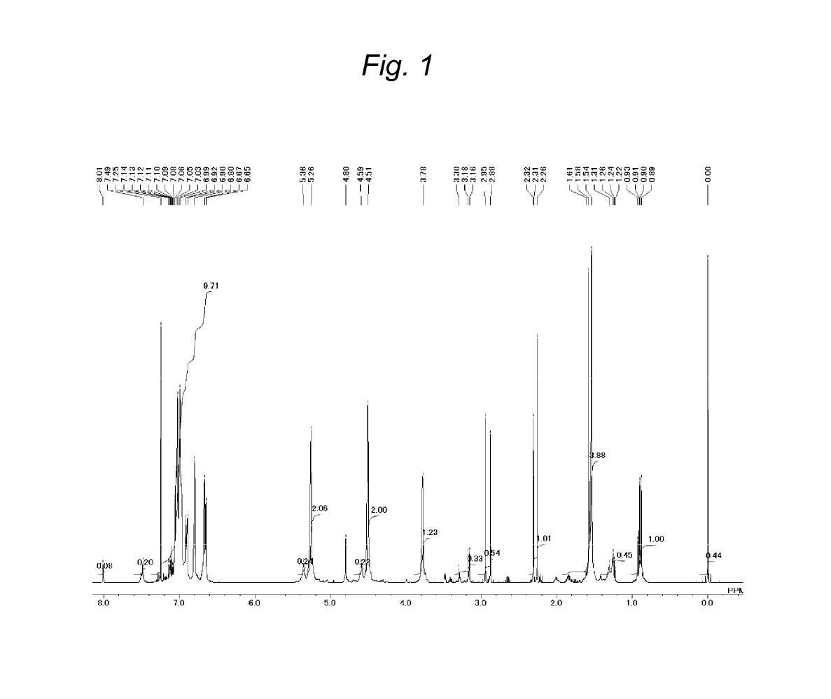

The ¹H-NMR spectrum of this compound is shown in FIG. 1.

### The Oxazine Ring of DHBP_MDA

The proton peak of methylene at position 2 of the oxazine ring: 5.36 ppm

The proton peak of methylene at position 4 of the oxazine ring: 4.59 ppm

### The Oxazine Ring of BisA_MDA

The proton peak of methylene at position 2 of the oxazine ring: 5.26 ppm

The proton peak of methylene at position 4 of the oxazine ring: 4.51 ppm
The proton peak of a methyl group derived from BisA: 1.54 ppm
The proton peak of a methylene group (—CH₂—) derived from MDA: 3.78 ppm

### Example 2

A 300 mL flask equipped with a pressure-equalizing dropping funnel with a cock and a Dimroth condenser was charged with 200 mL of γ-butyrolactone (manufactured by Wako Pure Chemical Industries, Ltd.), 7.76 g of DHBP (0.036 mol, manufactured by Wako Pure Chemical Industries, Ltd.), 19.18 g of BisA (0.084 mol, manufactured by GE Plastics Japan Ltd.), and 23.89 g of MDA (0.12 mol, manufactured by HODOGAYA CHEMICAL CO., LTD., the product name “DAM”), and a nitrogen gas purge was started in the system (flow rate: 15 mL/min). The reaction solution was stirred at 100° C. for 1 hour. After the dissolution of DHBP, BisA, and MDA was confirmed, 18.87 g of PFA (0.58 mol, manufactured by MITSUBISHI GAS CHEMICAL COMPANY, INC., purity: 91.60%) was added to the above flask, and the reaction solution was reacted for 3 hours. The reaction solution obtained in this manner was cooled to room temperature, filtered, and then poured into 1 L of methanol to precipitate a product.

The precipitate was dried under reduced pressure to obtain a thermosetting resin having a benzoxazine ring B. The weight-average molecular weight (Mw) of the obtained thermosetting resin having a benzoxazine ring B was about 6000.

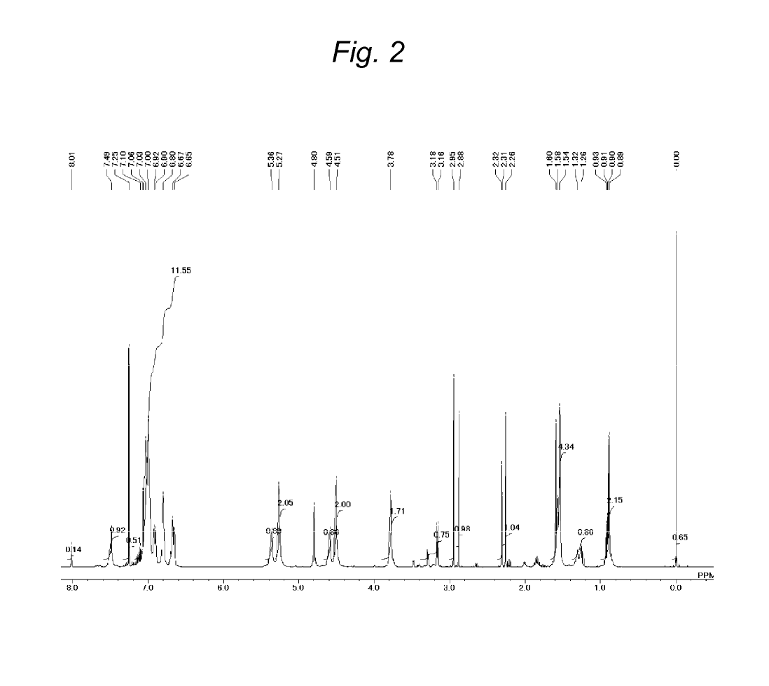

The ¹H-NMR spectrum of this compound is shown in FIG. 2.

### The Oxazine Ring of DHBP_MDA

The proton peak of methylene at position 2 of the oxazine ring: 5.36 ppm

The proton peak of methylene at position 4 of the oxazine ring: 4.59 ppm

### The Oxazine Ring of BisA_MDA

The proton peak of methylene at position 2 of the oxazine ring: 5.27 ppm

The proton peak of methylene at position 4 of the oxazine ring: 4.51 ppm
The proton peak of a methyl group derived from BisA: 1.54 ppm
The proton peak of a methylene group derived from MDA: 3.78 ppm

### Example 3

A 300 mL flask equipped with a pressure-equalizing dropping funnel with a cock and a Dimroth condenser was charged with 200 mL of γ-butyrolactone (manufactured by Wako Pure Chemical Industries, Ltd.), 18.12 g of DHBP (0.084 mol, manufactured by Wako Pure Chemical Industries, Ltd.), 8.22 g of BisA (0.036 mol, manufactured by GE Plastics Japan Ltd.), and 23.89 g of MDA (0.12 mol, manufactured by HODOGAYA CHEMICAL CO., LTD., the product name “DAM”), and a nitrogen gas purge was started in the system (flow rate: 15 mL/min). The reaction solution was stirred at 100° C. for 1 hour. After the dissolution of DHBP, BisA, and MDA was confirmed, 18.87 g of PFA (0.58 mol, manufactured by MITSUBISHI GAS CHEMICAL COMPANY, INC., purity: 91.60%) was added to the above flask, and the reaction solution was reacted for 4 hours. The reaction solution obtained in this manner was cooled to room temperature, filtered, and then poured into 1 L of methanol to precipitate a product.

The precipitate was dried under reduced pressure to obtain a thermosetting resin having a benzoxazine ring C. The weight-average molecular weight (Mw) of the obtained thermosetting resin having a benzoxazine ring C was about 8000.

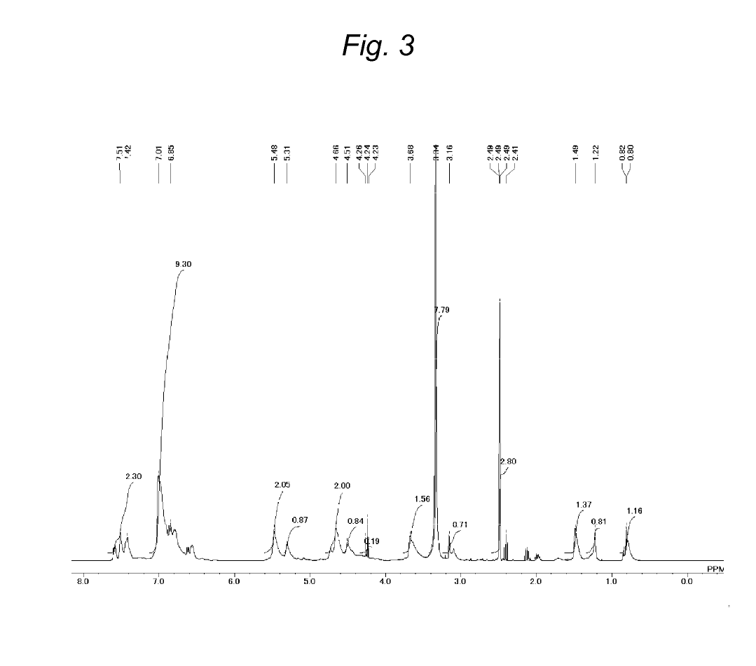

The ¹H-NMR spectrum of this compound is shown in FIG. 3.

### The Oxazine Ring of DHBP_MDA

The proton peak of methylene at position 2 of the oxazine ring: 5.48 ppm

The proton peak of methylene at position 4 of the oxazine ring: 4.66 ppm

### The Oxazine Ring of BisA_MDA

The proton peak of methylene at position 2 of the oxazine ring: 5.31 ppm

The proton peak of methylene at position 4 of the oxazine ring: 4.51 ppm
The proton peak of a methyl group derived from BisA: 1.49 ppm
The proton peak of a methylene group derived from MDA: 3.68 ppm

### Example 4

A 300 mL flask equipped with a pressure-equalizing dropping funnel with a cock and a Dimroth condenser was charged with 200 mL of γ-butyrolactone (manufactured by Wako Pure Chemical Industries, Ltd.), 12.94 g of DHBP (0.06 mol, manufactured by Wako Pure Chemical Industries, Ltd.), 13.70 g of BisA (0.06 mol, manufactured by GE Plastics Japan Ltd.), and 12.99 g of p-phenylenediamine (hereinafter also referred to as PDA) (0.12 mol, manufactured by Daishin chemical IND. co., LTD, the product name “Paramine”), and a nitrogen gas purge was started in the system (flow rate: 15 mL/min). The reaction solution was stirred at 100° C. for 1 hour. After the dissolution of DHBP, BisA, and PDA was confirmed, 18.87 g of PFA (0.58 mol, manufactured by MITSUBISHI GAS CHEMICAL COMPANY, INC., purity: 91.60%) was added to the above flask, and the reaction solution was reacted for 5 hours. The reaction solution obtained in this manner was cooled to room temperature, filtered, and then poured into 1 L of methanol to precipitate a product.

The precipitate was dried under reduced pressure to obtain a thermosetting resin having a benzoxazine ring D. The weight-average molecular weight (Mw) of the obtained thermosetting resin having a benzoxazine ring D was about 8000.

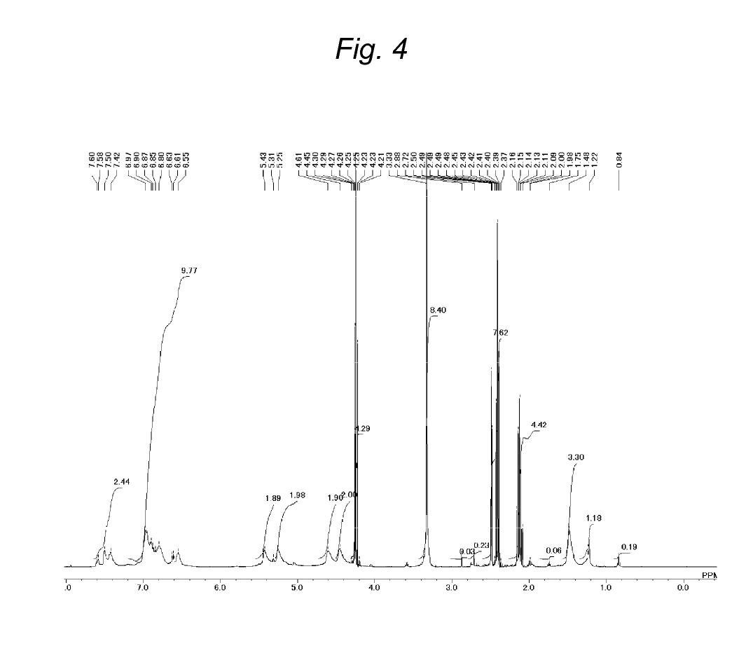

The ¹H-NMR spectrum of this compound is shown in FIG. 4.

### The Oxazine Ring of DHBP_PDA

The proton peak of methylene at position 2 of the oxazine ring: 5.43 ppm

The proton peak of methylene at position 4 of the oxazine ring: 4.61 ppm

### The Oxazine Ring of BisA_PDA

The proton peak of methylene at position 2 of the oxazine ring: 5.25 ppm

The proton peak of methylene at position 4 of the oxazine ring: 4.45 ppm
The proton peak of a methyl group derived from BisA: 1.48 ppm

### Example 5

A 300 mL flask equipped with a pressure-equalizing dropping funnel with a cock and a Dimroth condenser was charged with 200 mL of γ-butyrolactone (manufactured by Wako Pure Chemical Industries, Ltd.), 18.12 g of DHBP (0.084 mol, manufactured by Wako Pure Chemical Industries, Ltd.), 8.22 g of BisA (0.036 mol, manufactured by GE Plastics Japan Ltd.), and 12.99 g of PDA (0.12 mol, manufactured by Daishin chemical IND. co., LTD, the product name “Paramine”), and a nitrogen gas purge was started in the system (flow rate: 15 mL/min). The reaction solution was stirred at 100° C. for 1 hour. After the dissolution of DHBP, BisA, and PDA was confirmed, 18.87 g of PFA (0.58 mol, manufactured by MITSUBISHI GAS CHEMICAL COMPANY, INC., purity: 91.60%) was added to the above flask, and the reaction solution was reacted for 4 hours. The reaction solution obtained in this manner was cooled to room temperature, filtered, and then poured into 1 L of methanol to precipitate a product.

The precipitate was dried under reduced pressure to obtain a thermosetting resin having a benzoxazine ring E. The weight-average molecular weight (Mw) of the obtained thermosetting resin having a benzoxazine ring E was about 7000.

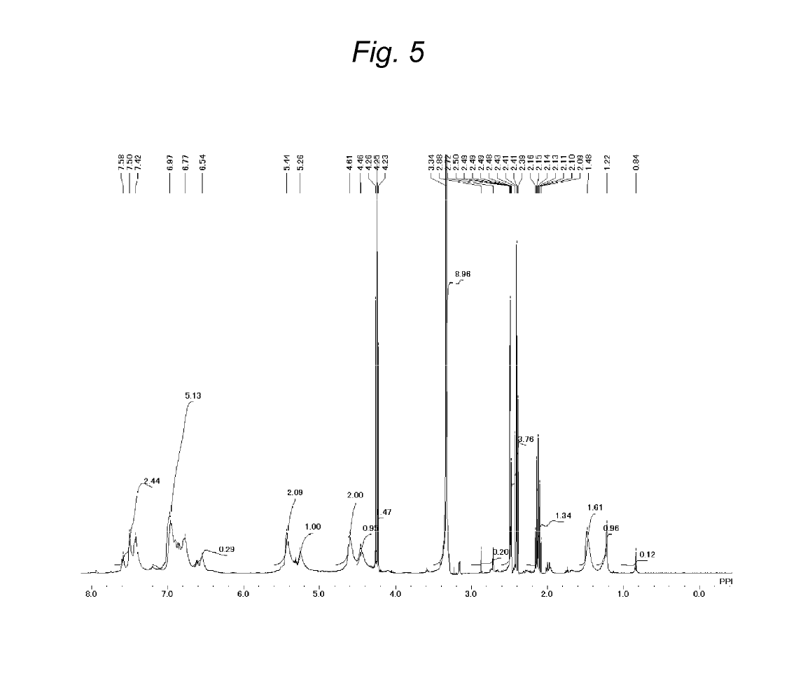

The ¹H-NMR spectrum of this compound is shown in FIG. 5.

### The Oxazine Ring of DHBP_PDA

The proton peak of methylene at position 2 of the oxazine ring: 5.44 ppm

The proton peak of methylene at position 4 of the oxazine ring: 4.61 ppm

### The Oxazine Ring of BisA_PDA

The proton peak of methylene at position 2 of the oxazine ring: 5.26 ppm

The proton peak of methylene at position 4 of the oxazine ring: 4.46 ppm
The proton peak of a methyl group derived from BisA: 1.48 ppm

### Example 6

A 300 mL flask equipped with a pressure-equalizing dropping funnel with a cock and a Dimroth condenser was charged with 200 mL of γ-butyrolactone (manufactured by Wako Pure Chemical Industries, Ltd.), 21.99 g of DHBP (0.102 mol, manufactured by Wako Pure Chemical Industries, Ltd.), 4.11 g of BisA (0.018 mol, manufactured by GE Plastics Japan Ltd.), and 12.99 g of PDA (0.12 mol, manufactured by Daishin chemical IND. co., LTD, the product name “Paramine”), and a nitrogen gas purge was started in the system (flow rate: 15 mL/min). The reaction solution was stirred at 100° C. for 1 hour. After the dissolution of DHBP, BisA, and PDA was confirmed, 18.87 g of PFA (0.58 mol, manufactured by MITSUBISHI GAS CHEMICAL COMPANY, INC., purity: 91.60%) was added to the above flask, and the reaction solution was reacted for 3 hours. The reaction solution obtained in this manner was cooled to room temperature, filtered, and then poured into 1 L of methanol to precipitate a product.

The precipitate was dried under reduced pressure to obtain a thermosetting resin having a benzoxazine ring F. The weight-average molecular weight (Mw) of the obtained thermosetting resin having a benzoxazine ring F was about 6000.

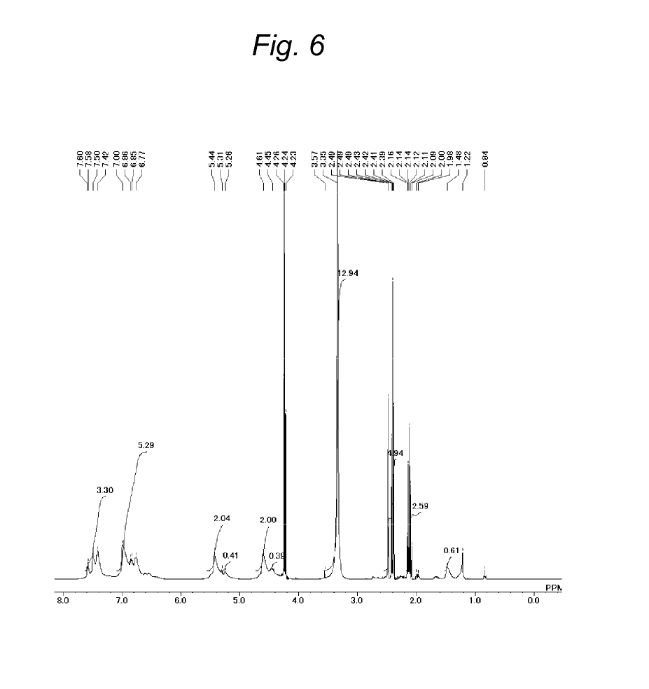

The ¹H-NMR spectrum of this compound is shown in FIG. 6.

### The Oxazine Ring of DHBP_PDA

The proton peak of methylene at position 2 of the oxazine ring: 5.44 ppm

The proton peak of methylene at position 4 of the oxazine ring: 4.61 ppm

### The Oxazine Ring of BisA_PDA

The proton peak of methylene at position 2 of the oxazine ring: 5.26 ppm

The proton peak of methylene at position 4 of the oxazine ring: 4.45 ppm
The proton peak of a methyl group derived from BisA: 1.48 ppm

### Example 7

A 300 mL flask equipped with a pressure-equalizing dropping funnel with a cock and a Dimroth condenser was charged with 200 mL of γ-butyrolactone (manufactured by Wako Pure Chemical Industries, Ltd.), 23.29 g of DHBP (0.108 mol, manufactured by Wako Pure Chemical Industries, Ltd.), 2.74 g of BisA (0.012 mol, manufactured by GE Plastics Japan Ltd.), and 12.99 g of PDA (0.12 mol, manufactured by Daishin chemical IND. co., LTD, the product name “Paramine”), and a nitrogen gas purge was started in the system (flow rate: 15 mL/min). The reaction solution was stirred at 100° C. for 1 hour. After the dissolution of DHBP, BisA, and PDA was confirmed, 18.87 g of PFA (0.58 mol, manufactured by MITSUBISHI GAS CHEMICAL COMPANY, INC., purity: 91.60%) was added to the above flask, and the reaction solution was reacted for 4 hours. The reaction solution obtained in this manner was cooled to room temperature, filtered, and then poured into 1 L of methanol to precipitate a product.

The precipitate was dried under reduced pressure to obtain a thermosetting resin having a benzoxazine ring G. The weight-average molecular weight (Mw) of the obtained thermosetting resin having a benzoxazine ring G was about 7000.

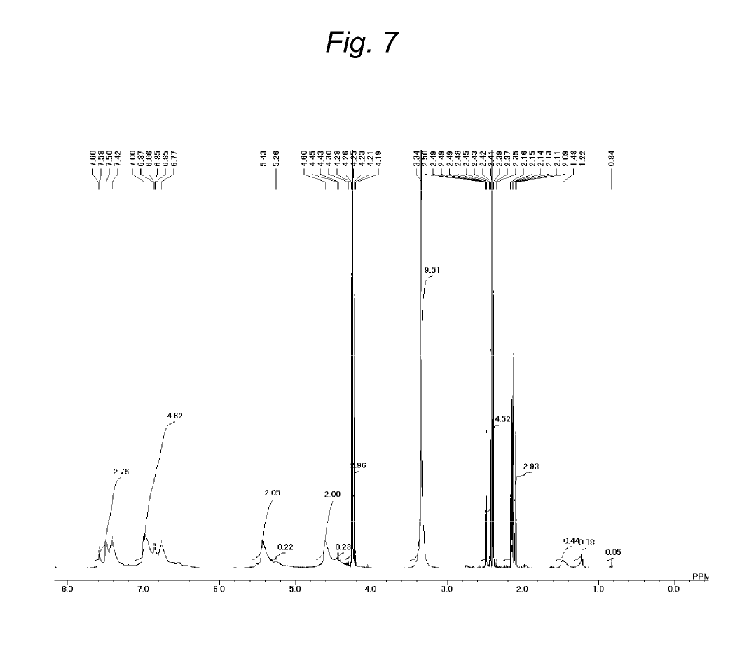

The ¹H-NMR spectrum of this compound is shown in FIG. 7.

### The Oxazine Ring of DHBP_PDA

The proton peak of methylene at position 2 of the oxazine ring: 5.43 ppm

The proton peak of methylene at position 4 of the oxazine ring: 4.60 ppm

### The Oxazine Ring of BisA_PDA

The proton peak of methylene at position 2 of the oxazine ring: 5.26 ppm

The proton peak of methylene at position 4 of the oxazine ring: 4.45 ppm
The proton peak of a methyl group derived from BisA: 1.48 ppm

### Comparative Example 1

190 mL of toluene and 10 mL of isobutanol were added and mixed in a 500 mL flask equipped with a pressure-equalizing dropping funnel with a cock and a Dimroth condenser under room temperature conditions.

Then, 27.4 g of BisA (0.12 mol, manufactured by GE Plastics Japan Ltd.), 51.3 g of 2,2′-bis[4-(4-aminophenoxy)phenyl]propane (hereinafter referred to as BAPP) (0.125 mol, manufactured by Wakayama Seika Kogyo Co., Ltd., the product name “BAPP”), and 0.9 g (0.0096 mol) of phenol were added and mixed in the above flask at room temperature. From this point of time, a nitrogen gas purge was started in the system (flow rate: 15 mL/min).

The reaction solution was dipped in an oil bath. After the temperature of the oil bath reached 65° C., the disappearance of the powdery substances was visually confirmed, and then, 19.5 g of PFA (0.60 mol, manufactured by MITSUBISHI GAS CHEMICAL COMPANY, INC., purity: 91.60%) was added to the above flask, and the reaction solution was reacted for 2 hours under reflux.

Then, the reaction solution was reacted, while water produced during the reaction was distilled off out of the system by being subjected to azeotropy with toluene and isobutanol. After the start of the distilling off, reflux was performed for 6 hours.

The reaction solution obtained in this manner was cooled to room temperature, filtered, and then poured into 1 L of methanol to precipitate a product. The precipitate was dried under reduced pressure to obtain a thermosetting resin having a benzoxazine ring H. The weight-average molecular weight of the obtained thermosetting resin having a benzoxazine ring H was about 16000.

### [Fabrication of Cured Film]

### Examples 8 to 10

6 g of each of the thermosetting resins fabricated in Examples 1 to 3 was dissolved in 5 g of dimethylformamide in a glass container to obtain a yellow viscous solution. This viscous solution was applied onto a polyimide (PI) film using an applicator, and thermally cured in an oven by being maintained at 80° C. for 10 minutes, at 100° C. for 10 minutes, at 150° C. for 10 minutes, at 180° C. for 30 minutes, at 200° C. for 30 minutes, at 220° C. for 30 minutes, at 240° C. for 30 minutes, and at 260° C. for 1 hour. By this thermal curing, film-shaped cured products (films A to C) were obtained. These cured products were yellow and transparent, and had a thickness of 45 μm.

### Examples 11 to 14

6 g of each of the thermosetting resins fabricated in Examples 4 to 7 was dissolved in 5 g of dimethylformamide in a glass container to obtain a red viscous solution. This viscous solution was applied onto a polyimide (PI) film using an applicator, and thermally cured in an oven by being maintained at 80° C. for 10 minutes, at 100° C. for 10 minutes, at 150° C. for 10 minutes, at 180° C. for 30 minutes, at 200° C. for 30 minutes, at 220° C. for 30 minutes, at 240° C. for 30 minutes, and at 260° C. for 1 hour. By this thermal curing, film-shaped cured products (films D to G) were obtained. These cured products were red and transparent, and had a thickness of 45 μm.

### Comparative Example 2

5 g of the thermosetting resin H fabricated in Comparative Example 1 was dissolved in 5 g of dimethylformamide in a glass container to obtain a yellow viscous solution. This viscous solution was applied onto a PI film using an applicator, and thermally cured in an oven by being maintained at 80° C. for 10 minutes, at 100° C. for 10 minutes, at 150° C. for 10 minutes, at 180° C. for 30 minutes, at 200° C. for 30 minutes, at 220° C. for 30 minutes, and at 240° C. for 1 hour. By this thermal curing, a film-shaped cured product (film H) was obtained. This cured product was yellow and transparent, and had a thickness of 51 μm. The viscous solution was thermally cured with an upper limit of 240° C. because it would have been pyrolyzed if it had been heated to 260° C.

The average value of the coefficients of linear thermal expansion of each film is shown in the following Table 1.

TABLE 1

| | | | | Final curing | CTE (ppm/° C.) |
|---|---|---|---|---|---|
| | Resin | | Film | Conditions | 25° C.-150° C. |
| Example 1 | A | Example 8 | A | 260° C. 1 h | 51 |
| Example 2 | B | Example 9 | B | (in air) | 50 |
| Example 3 | C | Example 10 | C | | 47 |
| Example 4 | D | Example 11 | D | 260° C. 1 h | 39 |
| Example 5 | E | Example 12 | E | (in air) | 36 |
| Example 6 | F | Example 13 | F | | 34 |
| Example 7 | G | Example 14 | G | | 33 |
| Comparative | H | Comparative | H | 240° C. 1 h | 58 |
| Example 1 | | Example 2 | | (in air) | |

[Solubility in Organic Solvents and Compatibility with Other Kinds of Resins]

### Example 15

0.1 g of the thermosetting resin E produced in Example 5, and 5 g of cyclohexanone (manufactured by Wako Pure Chemical Industries, Ltd.) were weighed into a glass container, and stirred by THINKY MIXER ARE-250 (manufactured by THINKY) for 10 minutes. A uniform solution in which the thermosetting resin E was dissolved was obtained.

### Comparative Example 3

A 300 mL flask equipped with a pressure-equalizing dropping funnel with a cock and a Dimroth condenser was charged with 200 mL of γ-butyrolactone (manufactured by Wako Pure Chemical Industries, Ltd.), 25.89 g of DHBP (0.12 mol, manufactured by Wako Pure Chemical Industries, Ltd.), and 12.99 g of PDA (0.12 mol, manufactured by Daishin chemical IND. co., LTD, the product name “Paramine”), and a nitrogen gas purge was started in the system (flow rate: 15 ml/min). The reaction solution was stirred at 100° C. for 1 hour. After the dissolution of DHBP and PDA was confirmed, 18.87 g of PFA (0.58 mol, manufactured by MITSUBISHI GAS CHEMICAL COMPANY, INC., purity: 91.60%) was added to the above flask, and the reaction solution was reacted for 4 hours. The reaction solution obtained in this manner was cooled to room temperature, filtered, and then poured into 1 L of methanol to precipitate a product.

The precipitate was dried under reduced pressure to obtain a thermosetting resin having a benzoxazine ring I. The weight-average molecular weight (Mw) of the obtained thermosetting resin having a benzoxazine ring I was about 7000.

### Comparative Example 4

0.1 g of the thermosetting resin I produced in Comparative Example 3, and 5 g of cyclohexanone (manufactured by Wako Pure Chemical Industries, Ltd.) were weighed into a glass container, and stirred by THINKY MIXER ARE-250 (manufactured by THINKY) for 10 minutes. But, the thermosetting resin I was insoluble.

### Example 16

0.1 g of the thermosetting resin E and 5 g of a bisphenol A type epoxy resin RE-410S (liquid, manufactured by Nippon Kayaku Co., Ltd.) were weighed into a glass container, and stirred by THINKY MIXER ARE-250 (manufactured by THINKY) for 10 minutes. The state of the obtained solution was visually observed to be uniform.

### Comparative Example 5

0.1 g of the thermosetting resin I and 5 g of a bisphenol A type epoxy resin RE-410S (liquid, manufactured by Nippon Kayaku Co., Ltd.) were weighed into a glass container, and stirred by THINKY MIXER ARE-250 (manufactured by THINKY) for 10 minutes. The state of the obtained solution was visually observed to be a turbid state.

### Example 17

0.1 g of the thermosetting resin E and 5 g of an alkylphenol monoglycidyl ether YED122 (liquid, manufactured by Mitsubishi Chemical Corporation) were weighed into a glass container, and stirred by THINKY MIXER ARE-250 (manufactured by THINKY) for 10 minutes. The state of the obtained solution was visually observed to be uniform.

### Comparative Example 6

0.1 g of the thermosetting resin I and 5 g of an alkylphenol monoglycidyl ether YED122 (liquid, manufactured by Mitsubishi Chemical Corporation) were weighed into a glass container, and stirred by THINKY MIXER ARE-250 (manufactured by THINKY) for 10 minutes. The state of the obtained solution was visually observed to be a turbid state.

From the above, it was confirmed that in Examples, a reduction in the coefficient of linear thermal expansion was intended, the dimensional stability was excellent, and the solubility in organic solvents and the compatibility with other kinds of resins were excellent.

The present application is based on Japanese Patent Application No. 2009-228803 filed with the Japan Patent Office on Sep. 30, 2009, the content of which is incorporated herein by reference.

### INDUSTRIAL APPLICABILITY

The thermosetting resin having a benzoxazine ring, the thermosetting resin composition, and the molded article and cured article thereof according to the present invention have industrial applicability in the fields of electronics materials, such as laminates and semiconductor sealing materials, and bonding materials, such as friction materials and grindstones, and further can also be suitably used as various electronic devices.

1.-16. (canceled)

17. A thermosetting resin having a benzoxazine ring, comprising a structure A represented by the following formula (1) and a structure B represented by the following formula (2) wherein at least either one of Y¹ in the structure A and Y² in the structure B is a structure represented by the following formula (3) or a structure represented by the following formula (4): 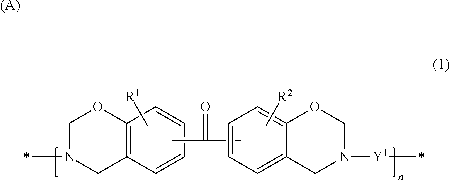
wherein R¹ and R² each independently represent hydrogen or an organic group having 1 to 20 carbon atoms, Y¹ represents an organic group that is an aliphatic diamine residue having a linear, branched, or cyclic structure or an aromatic diamine residue, wherein the organic group has 1 to 20 carbon atoms and may comprise a hetero element, and n represents an integer of 1 to 500; and * represents a bonding site, 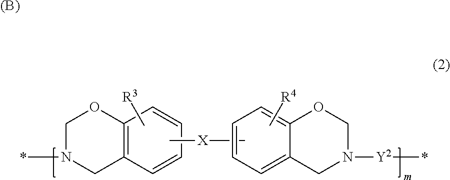
wherein R³ and R⁴ each independently represent hydrogen or an organic group having 1 to 20 carbon atoms, X represents an aliphatic organic group having a linear, branched, or cyclic structure or an aromatic organic group, wherein the organic group has 1 to 20 carbon atoms and may comprise a hetero element, Y² represents an organic group that is an aliphatic diamine residue having a linear, branched, or cyclic structure or an aromatic diamine residue, wherein the organic group has 1 to 20 carbon atoms and may comprise a hetero element, and m represents an integer of 1 to 500; and * represents a bonding site, 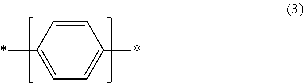
wherein * represents a bonding site, 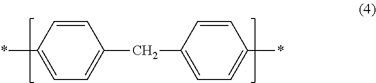
wherein * represents a bonding site.

18. The thermosetting resin having a benzoxazine ring according to claim 17, wherein R¹ and R² in the structure A are each hydrogen.

19. The thermosetting resin having a benzoxazine ring according to claim 17 or 18, wherein R¹ and R² in the structure A, and R³ and R⁴ in the structure B are each hydrogen.

20. The thermosetting resin according to claim 17 or 18, wherein a ratio of a content of the structure A to a content of the structure B (A/B; molar ratio) in the thermosetting resin is from 1/99 to 99/1.

21. The thermosetting resin according to claim 17 or 18, wherein the ratio of the content of the structure A to the content of the structure B (A/B; molar ratio) in the thermosetting resin is from 70/30 to 90/10.

22. The thermosetting resin having a benzoxazine ring according to claim 17 or 18, wherein X is at least one selected from the group consisting of the following group G1a: 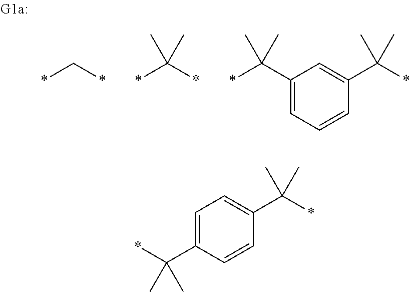
wherein * represents a bonding site.

23. A thermosetting resin having a benzoxazine ring obtained by reacting a compound represented by the following formula (5), a compound represented by the following formula (6), a diamine compound, and an aldehyde compound which is at least either one of a compound represented by the following formula (7) and a compound represented by the following formula (8): 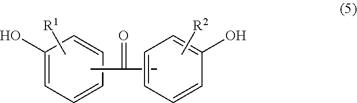
wherein R¹ and R² each independently represent hydrogen or an organic group having 1 to 20 carbon atoms, 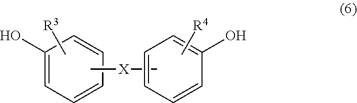
wherein R³ and R⁴ each independently represent hydrogen or an organic group having 1 to 20 carbon atoms, and X represents an aliphatic organic group having a linear, branched, or cyclic structure or an aromatic organic group, wherein the organic group has 1 to 20 carbon atoms and may comprise a hetero element,

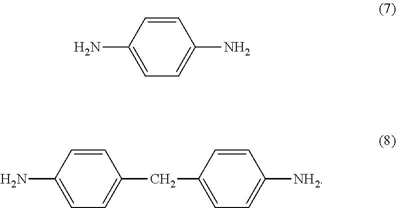

24. The thermosetting resin having a benzoxazine ring according to claim 23, wherein the reaction is performed in a lactone solvent.

25. A method for producing a thermosetting resin having a benzoxazine ring, comprising a step of reacting a compound represented by the following formula (5), a compound represented by the following formula (6), a diamine compound which is at least either one of a compound represented by the following formula (7) and a compound represented by the following formula (8), and an aldehyde compound: 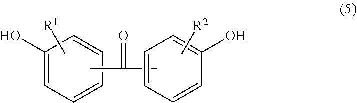
wherein R¹ and R² each independently represent hydrogen or an organic group having 1 to 20 carbon atoms, 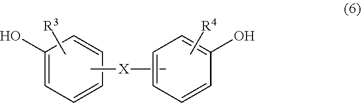
wherein R³ and R⁴ each independently represent hydrogen or an organic group having 1 to 20 carbon atoms, and X represents an aliphatic organic group having a linear, branched, or cyclic structure or an aromatic organic group, wherein the organic group has 1 to 20 carbon atoms and may comprise a hetero element,

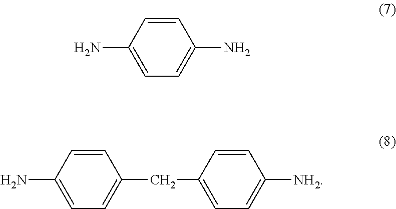

26. A thermosetting resin composition comprising the thermosetting resin according to claim 17 or 18.

27. A molded article obtained by molding the thermosetting resin according to claim 17 or 18.

28. A cured article obtained by curing the molded article according to claim 27.

29. An electronic device comprising a molded article according to claim 27.

30. An electronic device comprising a cured article according to claim 28.
